(19) United States
(12) Patent Application Publication
(10) Pub. No.: US 2025/0080157 A1
(43) Pub. Date: Mar. 6, 2025

(54) LOW-LATENCY HOST-SYNCHRONIZED TRANSMITTER OF A WIRELESS AUDIO SYSTEM

(71) Applicant: Skyworks Solutions, Inc., Irvine, CA (US)

(72) Inventors: Xudong Zhao, Portland, OR (US); Alexander Christian Stange, Portland, OR (US); Niranjan Manoharan, Greensboro, NC (US)

(21) Appl. No.: 18/824,659

(22) Filed: Sep. 4, 2024

Related U.S. Application Data
(60) Provisional application No. 63/580,923, filed on Sep. 6, 2023.
(60) Provisional application No. 63/679,982, filed on Aug. 6, 2024.

(51) Int. Cl. H04B 1/40; H04W 56/00

(52) U.S. Cl. CPC H04B 1/40; H04W 56/0015

(57) ABSTRACT

Systems of the present disclosure reduce end-to-end latency within a signal path of a wireless audio system by using a host synchronized link that bases synchronization on a start of frame signal from the host. The host synchronized link may be included in a transmitter. The use of the host-issued start of frame signal (e.g., from a USB controller) enables bypassing or omission of a sample rate converter. By bypassing the sample rate converter, the latency associated with the sample rate converter can be eliminated from the audio signal path.

### INCORPORATION BY REFERENCE

The present application claims priority to U.S. Provisional Application No. 63/580,923, filed on Sep. 6, 2023, and U.S. Provisional Application No. 63/679,982, filed on Aug. 6, 2024, the disclosures of each of which are hereby incorporated by reference in its entirety and for all purposes herein. Further, this application is being filed on Sep. 4, 2024, the same date as U.S. application Ser. No. ______ (Attorney Docket No. SKYWRKS.1479A2), which is titled “LOW-LATENCY HOST-SYNCHRONIZED RECEIVER OF A WIRELESS AUDIO SYSTEM” and is hereby expressly incorporated by reference herein in its entirety for all purposes. Any and all applications for which a foreign or domestic priority claim is identified in the Application Data Sheet as filed with the present application are hereby incorporated by reference under 37 CFR 1.57.

### TECHNICAL FIELD

The present disclosure relates to wireless audio communication and more specifically, to a low-latency host-synchronized wireless audio system.

### BACKGROUND

A computer system may include or support a number of peripherals. These peripherals can include speakers, headphones, microphones, and the like. Some of these peripherals may include a wired connection to the computer system. Other peripherals may include a wireless connection. The wireless connection may utilize a built-in communication that is included in the computer system, such as a Bluetooth® chip. In other cases, the communication may be achieved by connecting an external radio or wireless transceiver to a physical communication port of the computer system. This physical communication port could be a Universal Serial Bus (USB) port or other type of communication port.

### SUMMARY

The systems, methods and devices of this disclosure each have several innovative aspects, no single one of which is solely responsible for all of the desirable attributes disclosed herein. Details of one or more implementations of the subject matter described in this specification are set forth in the accompanying drawings and the description below.

In some aspects, the techniques described herein relate to a low-latency transmitter of a wireless audio output system, the low-latency transmitter including: an audio input configured to receive a start of frame signal and a set of audio samples from an audio source, the set of audio samples associated with an audio frame corresponding to the start of frame signal; a host synchronized link connected to the audio input, the host synchronized link including a frame sync generator, a host data controller, and a first in first out (FIFO) memory, the frame sync generator configured to receive the start of frame signal from the audio input and to generate a frame sync signal in response to the start of frame signal to synchronize audio samples with the start of frame, the host data controller configured to store the set of audio samples at the FIFO memory and to control output of the set of audio samples from the FIFO memory to an audio memory; and the audio memory configured to receive for transmission the set of audio samples associated with the audio frame from the host synchronized link at the end of the audio frame.

In some aspects, the techniques described herein relate to a low-latency transmitter wherein the host synchronized link bypasses a sample rate converter removing latency in audio transmission associated with the sample rate converter.

In some aspects, the techniques described herein relate to a low-latency transmitter further including a physical timing manager configured to control the host synchronized link and the audio memory.

In some aspects, the techniques described herein relate to a low-latency transmitter further including a baseband processor, the physical timing manager further configured to control the baseband processor.

In some aspects, the techniques described herein relate to a low-latency transmitter wherein the physical timing manager is further configured to receive the frame sync signal from the frame sync generator and to control synchronization of the audio samples with the start of the frame.

In some aspects, the techniques described herein relate to a low-latency transmitter wherein the host data controller controls the output of the set of audio samples from the FIFO memory to the audio memory based on a synchronized state between the start of frame signal and the physical timing manager.

In some aspects, the techniques described herein relate to a low-latency transmitter wherein, when the set of audio samples includes less than a particular number of samples, the host data controller concatenates samples from a prior set of audio samples stored at the FIFO memory to the set of audio samples.

In some aspects, the techniques described herein relate to a low-latency transmitter wherein the start of frame signal is received about every 1 millisecond.

In some aspects, the techniques described herein relate to a low-latency transmitter wherein the audio input is a universal serial bus (USB) input.

In some aspects, the techniques described herein relate to a low-latency transmitter wherein the host data controller includes a first handshake controller configured to establish a connection with the audio input and a second handshake controller configured to indicate if a sample from the set of audio samples is written to the audio memory.

In some aspects, the techniques described herein relate to a low-latency transmitter wherein a link rate between the low-latency transmitter and a receiver is controlled by a clock of the audio source.

In some aspects, the techniques described herein relate to a low-latency transmitter wherein the wireless audio output system includes a speaker.

In some aspects, the techniques described herein relate to a low-latency transmitter wherein the audio source is a computing system.

In some aspects, the techniques described herein relate to a wireless host including: a computing system configured to output audio as a set of audio samples to be wirelessly transmitted to a speaker; and a transmitter including an audio input, a host synchronized link, and audio memory, the audio input configured to receive a start of frame signal and the set of audio samples from the computing system, the set of audio samples associated with an audio frame corresponding to the start of frame signal, the host synchronized link connected to the audio input and including a frame sync generator, a host data controller, and a first in first out (FIFO) memory, the frame sync generator configured to receive the start of frame signal from the audio input and to generate a frame sync signal in response to the start of frame signal to synchronize audio samples with the start of frame, the host data controller configured to store the set of audio samples at the FIFO memory and to control output of the set of audio samples from the FIFO memory to the audio memory, and the audio memory configured to receive for transmission the set of audio samples associated with the audio frame from the host synchronized link at the end of the audio frame.

In some aspects, the techniques described herein relate to a wireless host wherein the transmitter further includes a physical timing manager configured to control the host synchronized link and the audio memory.

In some aspects, the techniques described herein relate to a wireless host wherein the physical timing manager is further configured to receive the frame sync signal from the frame sync generator and to control synchronization of the audio samples with the start of the frame.

In some aspects, the techniques described herein relate to a wireless host wherein, when the set of audio samples includes less than a particular number of samples, the host data controller includes samples from a prior set of audio samples stored at the FIFO memory with the set of audio samples to obtain the particular number of samples.

In some aspects, the techniques described herein relate to a wireless host wherein the start of frame signal is generated by a universal serial bus (USB) controller that provides the start of frame signal to the audio input.

In some aspects, the techniques described herein relate to a wireless audio system including: a wireless host configured to wirelessly transmit a set of audio samples to a speaker, the wireless host including a transmitter and a computing system configured to output the set of audio sample to the transmitter, the transmitter including an audio input, a host synchronized link, and audio memory, the audio input configured to receive a start of frame signal and the set of audio samples from the computing system, the set of audio samples associated with an audio frame corresponding to the start of frame signal, the host synchronized link connected to the audio input and including a frame sync generator, a host data controller, and a first in first out (FIFO) memory, the frame sync generator configured to receive the start of frame signal from the audio input and to generate a frame sync signal in response to the start of frame signal to synchronize audio samples with the start of frame, the host data controller configured to store the set of audio samples at the FIFO memory and to control output of the set of audio samples from the FIFO memory to the audio memory, and the audio memory configured to receive for transmission the set of audio samples associated with the audio frame from the host synchronized link at the end of the audio frame; and a wireless client configured to wirelessly receive the set of audio samples to output audio corresponding to the set of audio samples using the speaker.

In some aspects, the techniques described herein relate to a wireless audio system wherein the transmitter further includes a physical timing manager configured to receive the frame sync signal from the frame sync generator and to control synchronization of the audio samples with the start of the frame.

In some aspects, the techniques described herein relate to a low-latency receiver of a wireless audio input system, the low-latency receiver including: an audio output configured to provide a set of audio samples to a computing system, the audio output further configured to receive a start of frame signal from the computing system; a host synchronized link connected to the audio output, the host synchronized link including a frame sync generator, a host data controller, and a first in first out (FIFO) memory, the frame sync generator configured to receive the start of frame signal from the audio output and to generate a frame sync signal in response to the start of frame signal to synchronize audio samples with the start of frame, the host data controller configured to receive the set of audio samples from an audio memory and store the set of audio samples at the FIFO memory; and the audio memory configured to receive from a baseband processor the set of audio samples associated with an audio frame received from a wireless client.

In some aspects, the techniques described herein relate to a low-latency receiver wherein the wireless audio input system includes a microphone.

In some aspects, the techniques described herein relate to a low-latency receiver wherein the microphone provides an audio signal to the wireless client, the wireless client configured to generate the set of audio samples from the audio signal.

In some aspects, the techniques described herein relate to a low-latency receiver wherein the host synchronized link bypasses a sample rate converter removing latency associated with the sample rate converter when receiving audio.

In some aspects, the techniques described herein relate to a low-latency receiver further including an antenna configured to transmit the start of frame signal to the wireless client to synchronize the set of audio samples to be transmitted by the wireless client to the low-latency receiver.

In some aspects, the techniques described herein relate to a low-latency receiver further including a physical timing manager configured to control the host synchronized link and the audio memory.

In some aspects, the techniques described herein relate to a low-latency receiver wherein the physical timing manager is further configured to control the baseband processor.

In some aspects, the techniques described herein relate to a low-latency receiver wherein the physical timing manager is further configured to receive the frame sync signal from the frame sync generator and to control synchronization of the audio samples with the start of the frame.

In some aspects, the techniques described herein relate to a low-latency receiver wherein, when the set of audio samples includes less than a particular number of samples, the host data controller concatenates samples from a prior set of audio samples stored at the FIFO memory to the set of audio samples.

In some aspects, the techniques described herein relate to a low-latency receiver wherein the start of frame signal is received every 1 millisecond+/−500 nanoseconds.

In some aspects, the techniques described herein relate to a low-latency receiver wherein the audio output is a universal serial bus (USB) output.

In some aspects, the techniques described herein relate to a low-latency receiver wherein a link rate between the low-latency receiver and a transmitter is controlled by a clock of the computing system.

In some aspects, the techniques described herein relate to a wireless host including: a computing system configured to receive a set of audio samples obtained via a wireless connection to a microphone; and a receiver including an audio output, a host synchronized link, and an audio memory, the audio output configured to provide the set of audio samples to the computing system, the audio output further configured to receive a start of frame signal from the computing system, the host synchronized link connected to the audio output, the host synchronized link including a frame sync generator, a host data controller, and a first in first out (FIFO) memory, the frame sync generator configured to receive the start of frame signal from the audio output and to generate a frame sync signal in response to the start of frame signal to synchronize audio samples with the start of frame, the host data controller configured to receive the set of audio samples from the audio memory and store the set of audio samples at the FIFO memory, and the audio memory configured to receive from a baseband processor the set of audio samples associated with an audio frame received from the microphone.

In some aspects, the techniques described herein relate to a wireless host wherein the receiver is configured to transmit the start of frame signal to a wireless client in communication with the microphone to synchronize the set of audio samples to be transmitted by the wireless client to the receiver.

In some aspects, the techniques described herein relate to a wireless host wherein the receiver further includes a physical timing manager configured to receive the frame sync signal from the frame sync generator and to control synchronization of the audio samples with the start of the frame.

In some aspects, the techniques described herein relate to a wireless host wherein, when the set of audio samples includes less than a particular number of samples, the host data controller includes samples from a prior set of audio samples stored at the FIFO memory with the set of audio samples to obtain the particular number of samples.

In some aspects, the techniques described herein relate to a wireless host wherein the start of frame signal is generated by a universal serial bus (USB) controller that provides the start of frame signal to the audio output.

In some aspects, the techniques described herein relate to a wireless host wherein a link rate between the receiver and a transmitter in communication with the microphone is controlled by a clock of the computing system.

In some aspects, the techniques described herein relate to a wireless audio system including: a wireless client configured to wirelessly transmit a set of audio samples corresponding to audio captured by a microphone; and a wireless host configured to wirelessly receive the set of audio samples from the wireless client, the wireless host including a computing system and a receiver, the receiver including an audio output, a host synchronized link, and an audio memory, the audio output configured to provide the set of audio samples to the computing system, the audio output further configured to receive a start of frame signal from the computing system, the host synchronized link connected to the audio output, the host synchronized link including a frame sync generator, a host data controller, and a first in first out (FIFO) memory, the frame sync generator configured to receive the start of frame signal from the audio output and to generate a frame sync signal in response to the start of frame signal to synchronize audio samples with the start of frame, the host data controller configured to receive the set of audio samples from the audio memory and store the set of audio samples at the FIFO memory, and the audio memory configured to receive from a baseband processor the set of audio samples associated with an audio frame received from the microphone of the wireless client.

In some aspects, the techniques described herein relate to a wireless audio system wherein the receiver is configured to transmit the start of frame signal to the wireless client in communication with the microphone to synchronize the set of audio samples to be transmitted by the wireless client to the receiver.

Although certain embodiments and examples are disclosed herein, inventive subject matter extends beyond the examples in the specifically disclosed embodiments to other alternative embodiments and/or uses, and to modifications and equivalents thereof.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure. In addition, various features of different disclosed embodiments can be combined to form additional embodiments, which are part of this disclosure. Further, one or more features or structures can be removed or omitted.

FIG. 1 illustrates an example of a wireless audio system in accordance with certain embodiments.

FIG. 2 illustrates an example signal flow diagram of the wireless audio system of FIG. 1 in accordance with certain embodiments.

FIG. 3 illustrates an example timing diagram for the wireless audio system of FIG. 1 in accordance with certain embodiments.

FIG. 4 illustrates an example timing diagram for a host-synchronized wireless audio system in accordance with certain embodiments.

FIG. 5 illustrates an example signal flow diagram of a host-synchronized wireless audio system transmitting audio in accordance with certain embodiments.

FIG. 6 illustrates an example signal flow diagram of a host-synchronized wireless audio system receiving audio in accordance with certain embodiments.

FIG. 7 illustrates an example of a host synchronized link in accordance with certain embodiments.

FIG. 8 illustrates an example of a frame sync generator in accordance with certain embodiments.

FIG. 9 presents a flowchart of a process for determining when to send out a frame synchronization pulse to the physical timing manager in accordance with certain embodiments.

FIG. 10 illustrates an example of a host data controller in accordance with certain embodiments.

FIG. 11 presents a finite state machine for the host synchronized link in accordance with certain embodiments.

FIG. 12 illustrates an example of an audio memory in accordance with certain embodiments.

### DETAILED DESCRIPTION OF CERTAIN EMBODIMENTS

The headings provided herein, if any, are for convenience only and do not necessarily affect the scope or meaning of the claimed invention.

### Introduction

A user may use wireless peripherals with a computing system. One such wireless peripheral is a headset. The headset enables the user to listen to audio output by the computing system. Some headsets also include microphones. The microphone may be used to supply audio to the computing system.

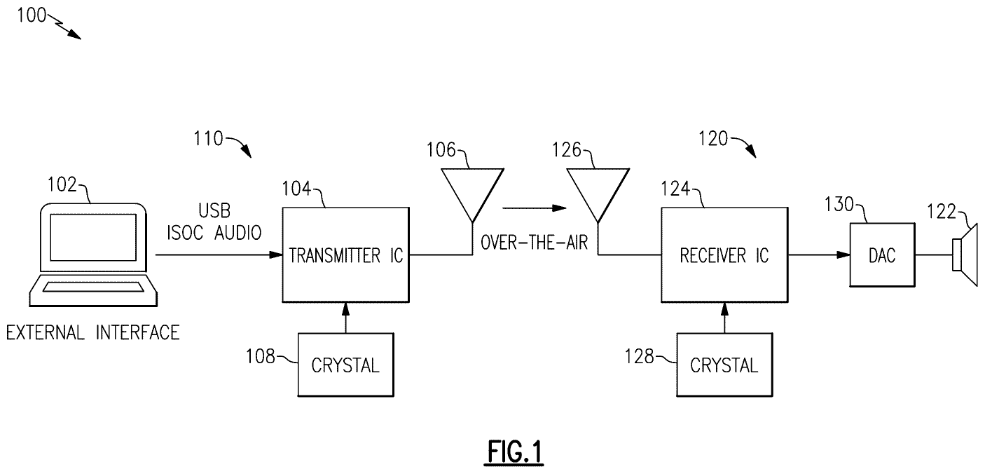

FIG. 1 illustrates an example of a wireless audio system 100 in accordance with certain embodiments. The wireless audio system 100 can include a wireless host 110 and a wireless client 120. The wireless host 110 may include a computing system 102, which may provide isochronous audio via a universal serial bus (USB) connection to a transmitter integrated circuit (IC), referred to as a transmitter 104 herein. The transmitter 104 may receive a clock signal from a crystal 108, which may be used to clock circuitry of the transmitter 104. The transmitter 104 may output packets to be transmitted by the antenna 106. The transmitted packets may be received by an antenna 126 of the wireless client 120. The packets received by the antenna 126 may be provided to a receiver IC, referred to as a receiver 124 herein. The receiver 124 may provide the packets to a digital to analog converter (DAC). The DAC 130 may provide the analog signal generated from the digital packets output by the receiver 124 to the speaker 122 to produce an audio output. As with the transmitter 104, the receiver 124 may receive a clock signal generated by a crystal 128.

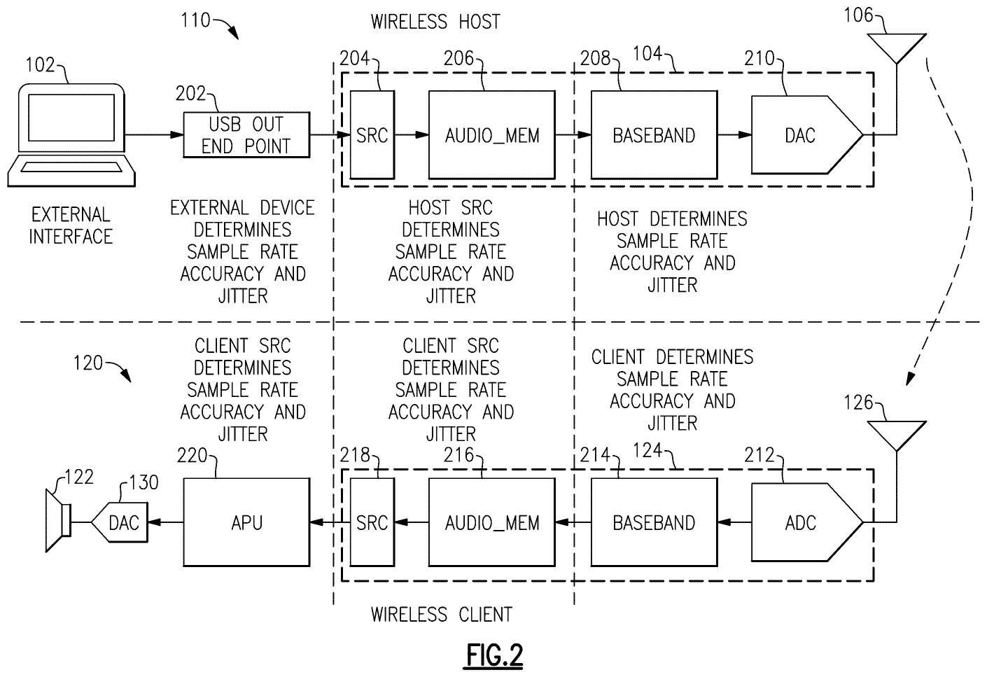

FIG. 2 illustrates an example signal flow diagram of the wireless audio system 100 of FIG. 1 in accordance with certain embodiments. In some embodiments, the computing system 102 can output one or more audio samples generated by or from an audio file being transmitted by the computing system 102. The audio samples may be output by an audio port, such as the USB port 202. The USB port 202 may supply the audio samples to the transmitter 104. The transmitter 104 may include a sample rate converter 204, which may modify a sample rate or sample frequency of the received audio from one rate to another rate for transmission by the transmitter 104. After the sample rate conversion by the sample rate converter 204, the audio samples are stored at the audio memory 206 until sufficient samples are collected for the audio frame to be transmitted as part of the audio packet. The audio packet or signal is provided to the baseband processor 208 and in turn to the digital to analog converter (DAC). The DAC 210 outputs the signal to the antenna 106 for transmission to the wireless client 120, which receives the transmitted signal at the antenna 126.

The received signal is provided to the receiver 124, which includes an analog to digital converter (ADC). The ADC 212 converts the received analog signal to a digital signal, which is provided to the baseband processor 214. The baseband processor 214 stores samples in the audio memory 216. The samples are provided to the sample rate converter 218 which, like the sample rate converter 204, modifies the sample rate or sample frequency of the audio signal. The output of the sample rate converter 218 is provided to the audio processing unit 220 and then the DAC 130 converts the digital signal to an analog signal that is output by the speaker 122.

The sample rate converter 204 and the sample rate converter 218 may be required when there is a change in the source clock for the audio samples. For samples from the computing system 102 to the transmitter 104, the computing system 102 may have a different clock, and thus a different sense of time. Thus, if programmed to the same nominal rate as the transmitter 104, the audio rate may have some difference in absolute sample rate, as well as jitter. Further, for samples from the transmitter 104 to the receiver 124, the timing is derived from two different crystals (e.g., the crystal 108 and the crystal 128), which may be nominally the same frequency but can naturally have some difference in frequency resulting in a difference in absolute sample rate, as well as jitter. The use of the sample rate converter 204 can address the timing issues.

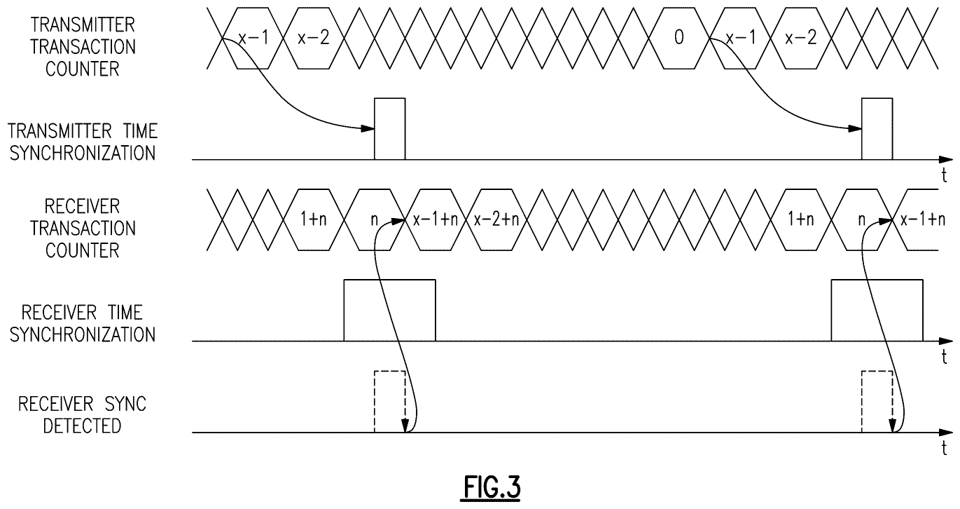

FIG. 3 illustrates an example timing diagram for the wireless audio system 100 of FIG. 1 in accordance with certain embodiments. The transmitter clock generated by the crystal 108 determines the audio sample rate in the receiver 124 of the wireless client 120 until the signal path reaches the sample rate converter 218. In other words, the wireless client 120 over-the-air timing follows that of the wireless host 110, which serves as the arbiter. As illustrated in FIG. 3, the transmitter transaction counter is implemented as a decrementing counter where the synchronization period may be determined by the number of cycles x derived from the crystal 108. The receiver 124 may have a larger receiver synchronization window because the receiver 124 may need to tolerate the signal from the transmitter 104 arriving earlier or later because the crystal 108 of the transmitter 104 may be faster or slower than the crystal 128 of the receiver 124.

As indicated above, the sample rate conversion may be needed when the clock rates are not identical. However, the sample rate conversion process can add end-to-end latency to the wireless communication between the wireless host 110 and the wireless client 120. It is desirable that the end-to-end latency is kept to a minimum (e.g., less than 4 milliseconds). In particular, when a user is using headphones to monitor the user's own voice, it is desirable to minimize latency to avoid echo.

Embodiments of the present disclosure reduce latency within the signal path by omitting or bypassing the sample rate converter 204. Thus, a low-latency transmitter can be provided for a wireless audio system. By bypassing the sample rate converter 204, the latency introduced by the sample rate converter 204 can be eliminated from the signal chain. Embodiments of the present disclosure enable the bypassing of the sample rate converter 204 by using the host start of frame signal that may be generated by the host (e.g., the computing system 102). This host start of frame signal may be generated by the USB controller of the computing system 102.

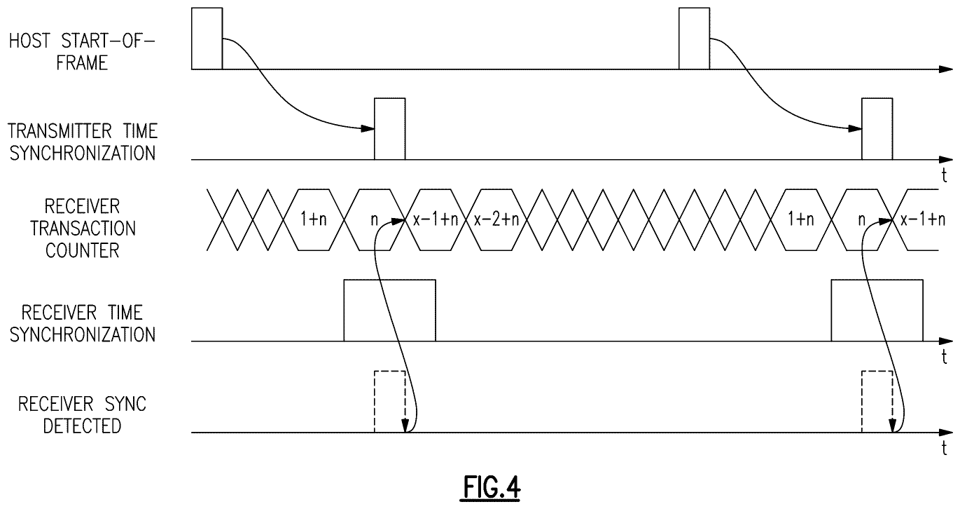

FIG. 4 illustrates an example timing diagram for a host-synchronized wireless audio system 100 in accordance with certain embodiments. While FIG. 3 illustrates the timing diagram for embodiments that implement a sample rater converter in both the wireless host 110 and the wireless client 120, the timing diagrams of FIG. 4 illustrate the use of a host start of frame signal for synchronizing communication between the transmitter and the receiver. Comparing the timing diagrams of FIG. 3 and FIG. 4, it can be determined that the use of the start of frame signal can achieve the same synchronization as using the clocks of the wireless host and the wireless client for synchronization. Using the start of frame signal, which may be generated by a USB controller of the computer system, there is a direct relationship between the sample rate of the host (e.g., the computer system) and the over-the-air rate of the transmitter 104 and the receiver 124. This means there is no longer a need for sample rate conversion on the arbiter (e.g., the wireless host 110). Accordingly, a sample rate converter can be omitted or bypassed enabling a reduction in end-to-end latency between the audio source (e.g., the computer system or a microphone) and an output device (e.g., a speaker or a computer system).

### Example Signal Flow Diagrams of Host-Synchronized Wireless Audio Systems

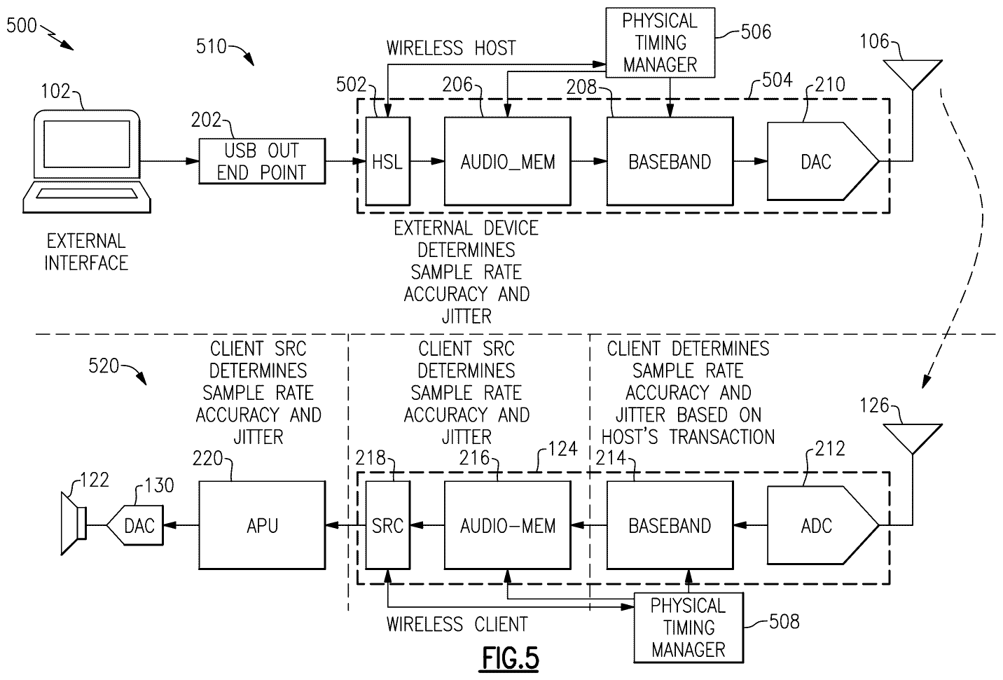

FIG. 5 illustrates an example signal flow diagram of a host-synchronized wireless audio system 500 transmitting audio in accordance with certain embodiments. The host-synchronized wireless audio system 500 can include a wireless host 510 and a wireless client 520. The wireless host 510 and the wireless client 520 may each include a radio, such as a transmitter, a receiver, or a transceiver. As with the wireless audio system 100, the host-synchronized wireless audio system 500 may include or be in communication with a computing system 102, which may output audio via the USB port 202. The USB port 202 may supply the audio to a transmitter 504, which under the control of a physical timing manager 506, may output an audio packet for transmission via the antenna 106 to a wireless client 520.

The USB of the computing system 102 may be a full-speed host. In some such cases where the USB is a full-speed host, the nominal start-of-frame period is 1 ms meaning that the transmitter 504 synchronizes to the host (e.g., the computing system 102) every 1 ms. In some cases, there may be up to +/−500 ns deviation in receipt of the start of frame signal. It should be understood that the present disclosure is not limited to USB and that other serial interfaces may be substituted for the USB port 202. For example, the USB port 202 may be substituted with SPDIF (Sony/Phillips Digital Interface) or I²S (Inter-IC Sound), and the like. Moreover, the USB port 202 can be replaced with any type of interface that can provide periodic synchronization with a known period and specified jitter. In certain embodiments, the transmitter 504 and the receiver 124 can establish an over-the-air link with a transaction length equal to an integer multiple of a frame period of the host interface (e.g., the computing system 102). If the host interface does not have frames and sends evenly-spaced samples as in I²S, the transaction length may be a multiple of the I²S sample period.

As with the transmitter 104, the transmitter 504 may include an audio memory 206, a baseband processor 208, and a DAC 210. However, unlike the transmitter 104, the transmitter 504 may include a host synchronized link 502. The host synchronized link 502 may enable the sample rate converter to be omitted. In some embodiments, the sample rate converter may be used for other tasks. Accordingly, the transmitter 504 may include the sample rate converter, but the sample rate converter may be bypassed as part of the transmission signal chain. The host synchronized link 502 may be configured to synchronize the transmission of packets based on the start of frame signal received from the host (e.g., from the USB port 202 of the computing system 102). Additional details relating to the host synchronized link 502 are disclosed below. Advantageously, instead of using its own rate source (e.g., a crystal 108 or a clock generated based on the crystal 108), the host synchronized link 502 may synchronize audio samples received from the USB port 202 using the start of frame signal received from the USB port 202.

The operation of the host synchronized link 502, the audio memory 206, and the baseband processor 208 may be controlled, at least in part, by the physical timing manager 506. The physical timing manager 506 may include a master or primary timer that synchronizes a transaction length of an audio packet. The physical timing manager 506 may include a timer that enables it to synchronize the transmission of the audio packets based on an indication of receipt of a start of frame from the USB port 202. The physical timing manager 506 may perform the synchronization in conjunction with a frame sync generator of the host synchronized link 502, which is discussed in more detail below.

The transmitter 504 may transmit an audio packet to the wireless client 520. The wireless client 520 may include one or more of the embodiments previously described with respect to the wireless client 120. Further, as with the wireless host 510, the wireless client 520 may include a physical timing manager 508. The physical timing manager 508 may include one or more of the embodiments of the physical timing manager 506. The physical timing manager 508 may control operation and timing of the elements of the receiver 124, including the sample rate converter 218, the audio memory 216, and the baseband processor 214.

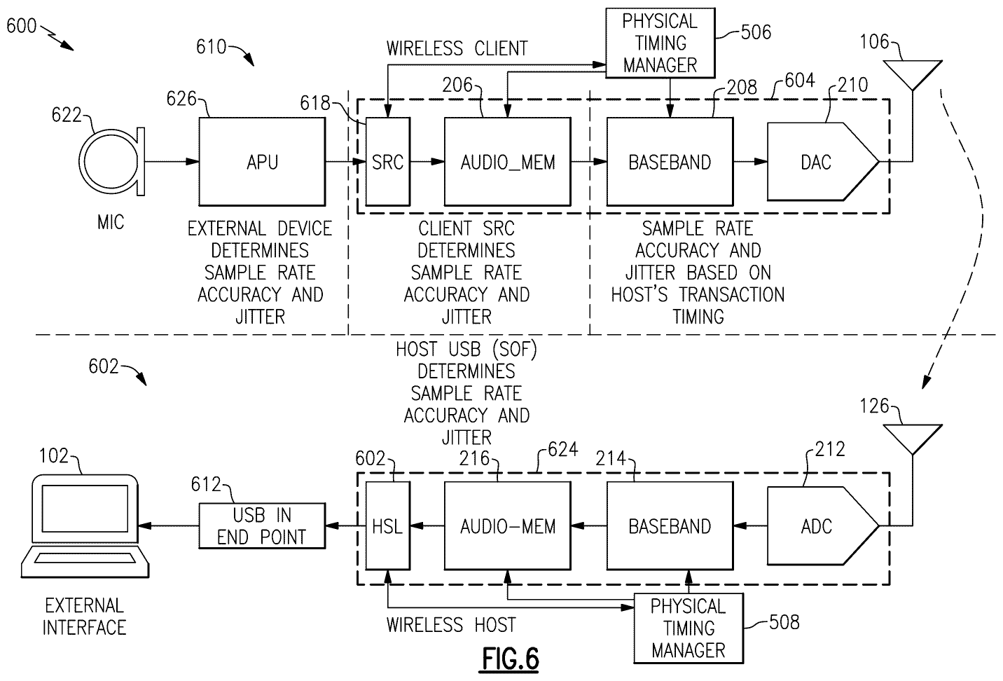

In certain embodiments, the timing of one of the transmitter 504 or the receiver 124 can be controlled by the start of frame signal from the USB port 202. In FIG. 5, the start of frame signal is received by the transmitter 504 and the synchronization of packets is based on the received start of frame signal from the USB port 202 and generated by USB controller of the computing system 102. FIG. 6 illustrates an example signal flow where the receiver receives the start of frame signal. The signal flow is similar when the receiver receives the start of frame as compared to when the transmitter receives the start of frame. In either case, the start of frame may be synchronized to the transmit packet boundaries.

FIG. 6 illustrates an example signal flow diagram of a host-synchronized wireless audio system 600 receiving audio in accordance with certain embodiments. The host-synchronized wireless audio system 600 can include a wireless client 610 and a wireless host 620. The wireless host 620 may be configured to receive audio packets from the wireless client 610 and to provide the audio packets to the computing system 102 via a USB port 612. The computing system 102 may store the received audio packets and/or play the received audio packets via speakers (not shown) of the computing system 102.

The wireless client 610 may include and/or be in communication with a microphone 622. The microphone 622 may provide audio to the wireless client 610. The audio may be received by an audio processing unit 626 of the wireless client 610. The wireless host 620 may determine sample rate accuracy and jitter of the audio received from the microphone 622. The wireless host 620 may generate audio samples from the received audio. The audio samples may be provided to the transmitter 604. The transmitter 604 may include a sample rate converter 618, audio memory 206, baseband processor 208, and/or a DAC 210. The sample rate converter 618 may modify the frequency of the audio. In some cases, the physical timing manager 506 may use a start of frame signal to control the operation of the sample rate converter 618 and/or the sample rate conversion of the received audio samples. The start of frame signal may be transmitted from the wireless host 620 to the wireless client 610 to enable the physical timing manager 506 to synchronize the audio samples based on the start of frame signal. The DAC 210 may convert an audio packet to an analog signal, which may be emitted by the antenna 106.

The wireless host 620 may receive the data packets via the antenna 126. The data packets may be processed by the receiver 624. The receiver 624 may then provide the audio packet to the USB port 612 to provide to the computing system 102. The receiver 624 may include a audio memory 216, a baseband processor 214, and an ADC 212. Further, the receiver 624 may include a host synchronized link 602. The host synchronized link 602 may operate in place of a sample rate converter enabling the receiver 624 to omit or bypass the sample rate converter when processing received packets. The host synchronized link 602 may be used to synchronize audio samples included in the received audio packet.

In certain embodiments, the physical timing manager 508 is configured to track the start of frame boundaries output by the USB port 612 from the computing system 102. This in turn also drives operation of the wireless host 620 and the wireless client 610 through timing tracking transaction boundaries to follow the USB's start of frame. The wireless host 620 may receive the over the air audio samples from the wireless client 610 and may fill a buffer (e.g., a FIFO memory) of the host synchronized link 602. The buffer of the host synchronized link 602, once filled to designated number of samples, will burst or flush the samples to the USB endpoint (e.g., the USB port 612). This mode or example operation synchronizes the physical timing manager 508 to the output endpoint of the USB. Since no sample rate conversion is required in this mode, the sample rate converter can be omitted or bypassed.

### Example Host Synchronized Link

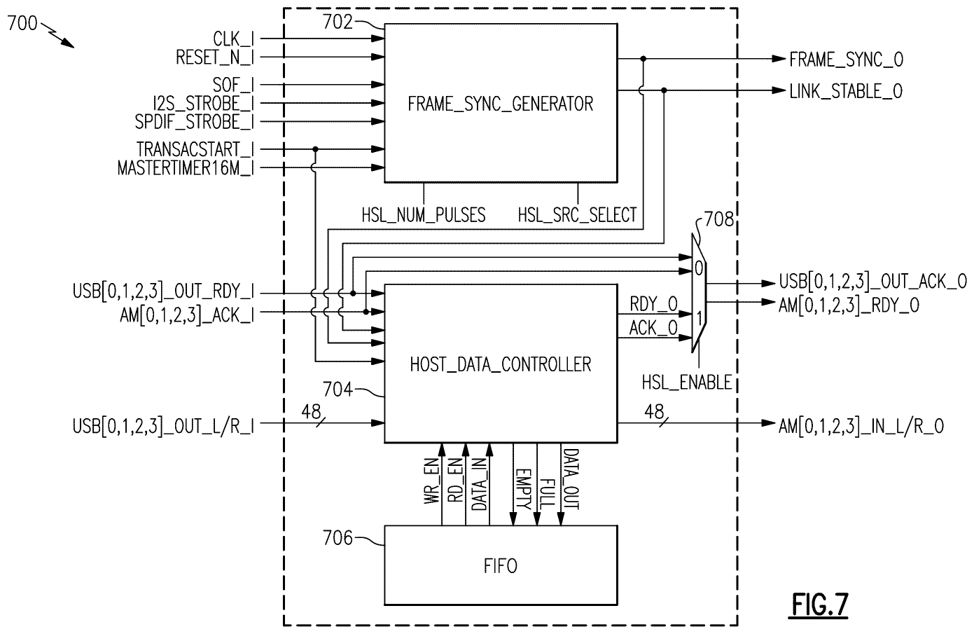

FIG. 7 illustrates an example of a host synchronized link 700 in accordance with certain embodiments. The host synchronized link 700 illustrated in FIG. 7 may be an example of the host synchronized link 502 and/or the host synchronized link 602. The host synchronized link 700 may be positioned between the USB port and the radio of the transmitter. In some cases, the host synchronized link 700 may be positioned between a sample rate converter and the radio. Although a sample rate converter may exist within the wireless host or the wireless client, the sample rate converter may provide samples from the USB port directly to the host synchronized link 700 without performing the sample rate operation thereby bypassing the sample rate converter. The link 700 may in turn provide the audio samples to an audio memory. The USB ready and ack signals may also be routed through the link 700 for additional processing to handle USB sample jitter. The signal (frame_sync_o) used by the physical timing manager to synchronize to the wireless host may also be generated by the link 700.

As discussed previously and as illustrated in FIG. 7, the host synchronized link 700 can receive and/or output audio samples to a USB port, such as the USB port 202 or the USB port 612. The host synchronized link 700 may include a frame sync generator 702, a host data controller 704, and a first in first out (FIFO) memory, referred to as a FIFO 706 herein. Further, the host synchronized link 700 may include a multiplexer 708. When the host synchronized link 700 is enabled, the multiplexer 708 may be configured to output audio samples from the host data controller 704 that the host data controller 704 retrieves from the FIFO 706. When the host synchronized link 700 is not enabled, the multiplexer 708 may be configured to provide audio samples directly from the USB port.

The frame sync generator 702, described in more detail below, may determine when to send a pulse or signal to the physical timing manager to synchronize a transaction length to a multiple of the wireless hosts pulse period. In other words, the frame sync generator 702 may send a control signal to the physical timing manager when a new start of frame signal is received by the host synchronized link 700 enabling the physical timing manager to synchronize communication based on the start of frame signal output by the USB port.

The host data controller 704 may be configured to control the storage of audio samples to the FIFO 706. Further, the host data controller 704 may be configured to control retrieval of audio sample from the FIFO 706 and to provide the retrieved audio samples to the audio memory. The host data controller 704 is described in more detail below.

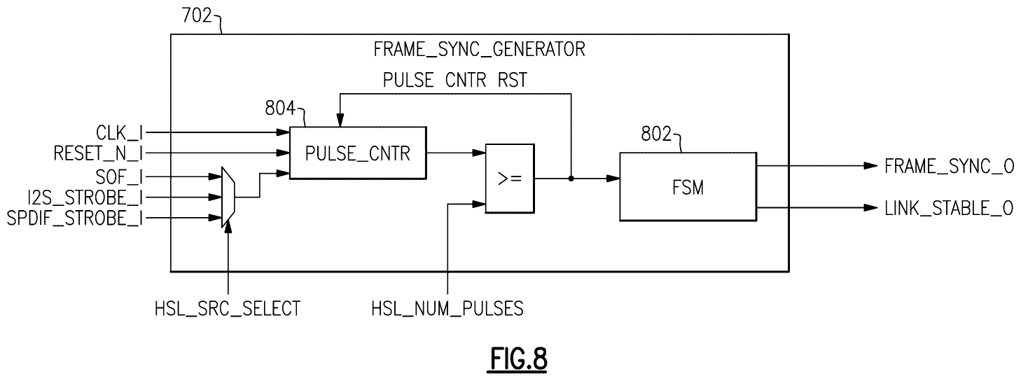

FIG. 8 illustrates an example of a frame sync generator 702 in accordance with certain embodiments. The frame sync generator 702 may include a controller 802 for executing a finite state machine and a pulse counter 804.

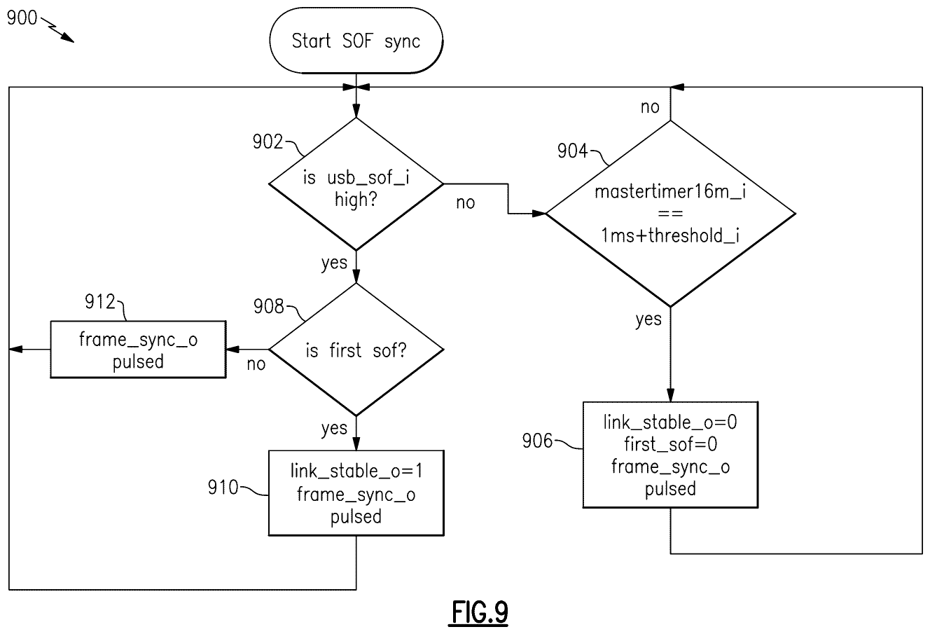

The frame sync generator 702 may generate a signal (e.g., the frame_sync_o signal) that depends on the number of input pulses counted (programmed in HSL_NUM_PULSES) and the current state of the physical timing manager. Additional details are described below with respect to FIG. 9. The controller 802 can determine when to send out the frame_sync_o pulse to the physical timing manager to synchronize the transaction length to a multiple of the wireless host's pulse period. In addition, the controller 802 can determine whether a communication link to the USB port is stable (e.g., the link_stable_o signal) or if the link has been disconnected.

FIG. 9 presents a flowchart of a process 900 for determining when to send out a frame synchronization pulse to the physical timing manager in accordance with certain embodiments. The process 900 may be performed by a frame sync generator 702. For example, the controller 802 of the frame sync generator 702 may execute the process 900.

The process 900 begins when a start of frame signal is received from the USB port. If an initial start of frame signal is not received, the process 900 does not initiate. If the process 900 has been initiated (e.g., a start of frame signal was previously received), and a start of frame signal is not received within a threshold period of time, the process 900 may indicate that a connection to the USB port has been lost or is no longer stable.

In host synchronized link mode (e.g., when the host synchronized link operates in place of a sample rate converter), the physical timing manager may reset based on the state of the usb_sof pulse (e.g., receipt of a start of frame signal).

At the decision block 902, the controller 802 determines whether a start of frame signal has been received (e.g., whether the usb_sof_i signal is high). If the start of frame signal has not been received, the controller 802 determines at decision block 904 whether a frame interval has been reached +/−a threshold time allotted for jitter. If so, at block 906, the controller 802 will cause the frame sync generator 702 to output a synchronization pulse to the physical timing manager regulating the timing of communication between the wireless host and the wireless client. Further, the controller 802 sets the link stable signal to low to indicate that the USB connection is unstable.

If the controller 802 determines at the decision block 902 that the start of frame signal has been received, the controller 802 determines whether the start of frame signal is the first start of frame signal at the decision block 908. If so, at block 910, the controller 802 sets the link stable signal to high and causes the frame sync generator 702 to output a synchronization pulse to the physical timing manager regulating the timing of communication between the wireless host and the wireless client. If not, at block 912, the controller 802 causes the frame sync generator 702 to output a synchronization pulse to the physical timing manager regulating the timing of communication between the wireless host and the wireless client.

As described, the block 906, the block 910, and the block 912 can send the frame synchronization pulse to the physical timing manager. In an ideal case, the start of frame signal will pulse every 1 ms and can reset the master timer to maintain the arbiter (e.g., the transmitter of the wireless host) 1 ms boundary. In some embodiments, in the event that the USB link is lost (e.g., start of frame pulses are no longer received), the controller 802 can maintain the 1 ms period, or other designated time period, as a default time period.

The start of frame signal may have a frame interval defined between 1 ms+500 ns or 1 ms-500 ns. In some cases, the timing tracking can handle up to +/−1000 ns of jitter. In other cases, the timing tracker may handle more or less jitter.

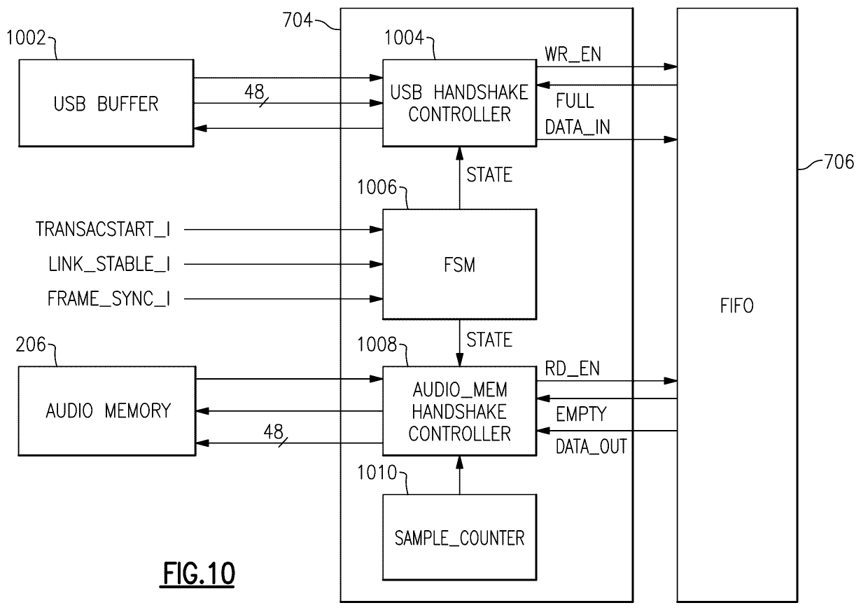

FIG. 10 illustrates an example of a host data controller 704 in accordance with certain embodiments. The host data controller 704 may regulate transmission of audio packets by storing samples in the FIFO 706 over a tracking time period and retrieving the stored samples for transmission at the end of a frame corresponding to the tracking time period. In cases where less than a target number of samples are obtained over the tracking time period, samples from a prior frame may be concatenated to otherwise included with samples from the current frame so as to maintain a consistent number of samples per frame. These audio samples may be added to a packet for transmission from the wireless host to the wireless client. In certain embodiments, the host data controller 704 may perform similar operations as a sample rate converter, but on a smaller scale reducing the impact on the end-to-end latency in communication compared to using the sample rate converter. The host data controller 704 unlike a sample rate converter is not performing sample rate conversion or recognition. Instead, the host data controller 704 is putting the raw audio samples directly into the FIFO 706 until the full window or frame of samples is collected. Once the frame of samples is collected, the host data controller 704 retrieves the samples from the FIFO 706 and provides the samples to the audio memory 216. The audio memory 216 may gather the audio samples for transmission and arrange them for processing by the baseband processor 208 in preparation for transmission by the antenna 106.

The host data controller 704 may include a USB handshake controller 1004, a controller 1006 configured to execute a finite state machine, an audio memory handshake controller 1008, and a sample counter 1010. The USB handshake controller 1004 may perform a handshake process with the USB controller of the computing system 102 via the USB port 202. The host data controller 704 may receive audio samples from the USB port 202 via the USB handshake controller 1004. In some cases, the USB handshake controller 1004 may perform the handshake process with a sample rate converter. Although the sample rate converter may not perform a sample rate conversion process, the sample rate converter may exist between the USB port 202 and the host synchronized link 502. In some such cases, the handshaking processing may be with the sample rate converter and the sample rate converter may provide the USB data (e.g., the audio samples) from the USB port 202 to the USB handshake controller 1004.

The audio memory handshake controller 1008 may perform a handshake process with the audio memory 216. When the host data controller 704 determines that the frame time period has elapsed, the host data controller 704 may retrieve audio samples from the FIFO 706 and provide the samples to the audio memory 206 via the audio memory handshake controller 1008. The sample counter 1010 may track the number of samples transmitted via the audio memory handshake controller 1008 from the FIFO 706 to the audio memory 206. If it is determined that there is a deficit in the number of samples, the host data controller 704 may address the deficiency in samples by retrieving samples from a prior frame.

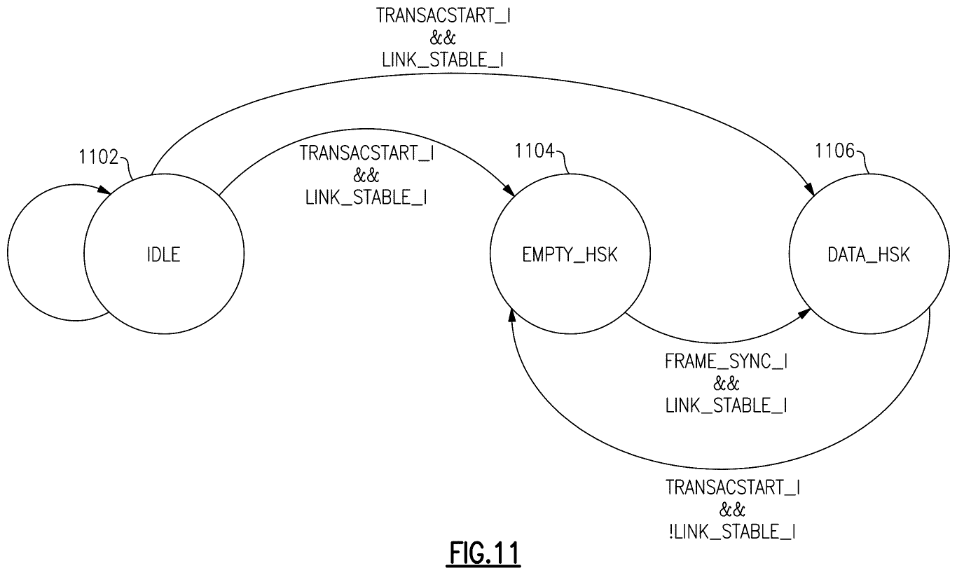

The controller 1006 may control operation of the host data controller 704 by executing a finite state machine to selectively control when to output samples to the audio memory 206. The finite state machine is illustrated in FIG. 11. The USB can dynamically scale the number of samples transmitted during isochronous transfers. For example, one frame can have 48 samples, the next frame may have 47 samples, and the frame after that may have 49 samples. The host data controller 704 may pace the number of samples out to the audio memory 206 at 48 samples per burst from the USB using the FIFO 706. The number of samples to burst can be programmed to support slower or faster over the air transmission rates. In other words, the present disclosure is not limited to 48 samples/frame and may operate with more or fewer samples.

To handle varied number of samples per frame. The FIFO 706 write pointer can be started from a programmed offset from 0. In other words, the FIFO 706 can start from a non-empty state. It can be assumed that the offset locations store zeros. By offsetting the storage, it can be ensured there are 48 samples to transmit per transaction.

For example, suppose a USB port 202 provides 48 samples at frame 0. The host data controller 704 can retrieve four 0s from the offset locations in the FIFO 706 and 44 samples from the frame 0 transmission received from the USB port 202. Four samples from the frame 0 transmission remain in the FIFO 706. Now suppose at frame 1, the USB port 202 provides 47 samples. The host data controller 704 may retrieve the 4 remaining samples from frame 0 stored in the FIFO 706 and 44 samples from frame 1 to complete the 48-sample transmission. Three samples from frame 1 now remain in the FIFO 706. Now support at frame 2, the USB port 202 provides 49 samples. The host data controller 704 can retrieve the 3 remaining samples from frame 1 stores in the FIFO 706 and use 45 samples from frame 2 to form the 48-sample packet. Four samples from frame 2 will remain in the FIFO 706. The FIFO 706 may be 48 bits×8 so as to support USB. However, it is possible for other serial connection mechanisms to be supported, such as I²S.

FIG. 11 presents a finite state machine for the host synchronized link in accordance with certain embodiments. The finite state machine may be implemented by the controller 1006 of the host data controller 704. The host data controller 704 can selectively send out data samples or zeros to the audio memory 206 depending on the synchronized state between the start of frame signal and the physical timing manager 506.

When in the idle state 1102, the host data controller 704 operates in a standby or waiting mode until an event triggers a change of state. In the empty state 1104, the physical timing manager 506 has initiated a transaction, but the USB port 202 has not provided a start of frame signal. Thus, for example, a transaction has started and a link with the computing system 102 is stable, but audio transmission has not started yet. In the empty state 1104, the host synchronized link 502 may have acknowledged a USB request, but has not yet received audio samples to load into the FIFO 706. Further, in the empty state 1104 the audio memory may be provided with 0s or without any data for transmission.

Upon receipt of a start of frame signal, and if the link to the USB port 202 remains stable, the host data controller 704 proceeds to the data receipt state 1106. In the data receipt state 1106, the physical timing manager 506 receives the frame synchronization signal indicating receipt of the start of frame signal from the USB port 202. Data (e.g., audio samples) received from the USB port 202 may be provided to the FIFO 706 (e.g., via the USB handshake controller 1004 and/or a sample rate converter) for storage. Upon end of frame, the audio samples may be retrieved from the FIFO 706 and provided to the audio memory 206 via, for example, the audio memory handshake controller 1008. If the FIFO 706 runs out of data, 0s may be provided for the remainder of the frame.

Generally, once the host data controller 704 transitions from the idle state 1102 to the empty state 1104, the host data controller 704 is to remain in one of the empty state 1104 or the data receipt state 1106. If the host data controller 704 transitions back to the idle state 1102 state, an interrupt may be thrown to a processor (not shown) to indicate a potential error.

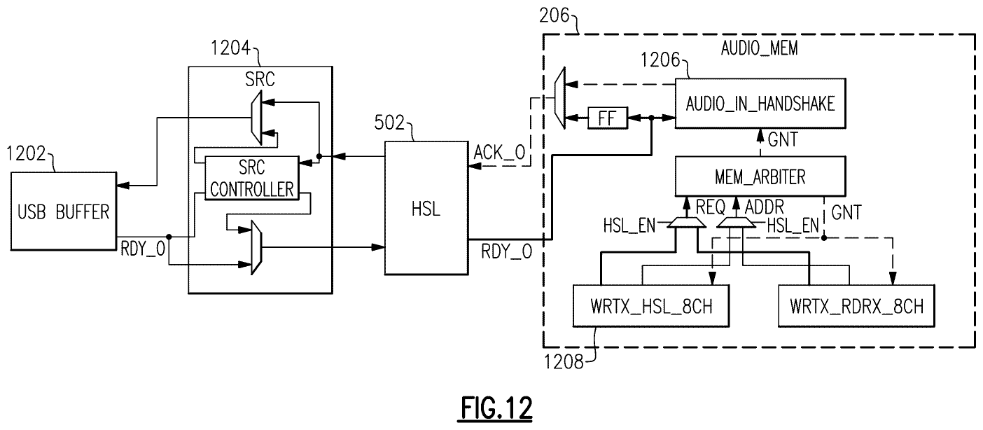

FIG. 12 illustrates an example of an audio memory 206 in accordance with certain embodiments. As previously described, the audio memory 206 may receive audio samples from the host synchronized link 502. In some cases, the host synchronized link 502 receives the audio from a USB port 202 or from a USB buffer 1202 that is connected to the USB port 202. Alternatively, or in addition, the host synchronized link 502 may receive the audio samples from a sample rate converter 1204 that is between the USB buffer 1202 and the host synchronized link 502. As previously described, the sample rate converter 1204 may not perform sample rate conversion in some cases to reduce latency introduced by the sample rate converter 1204. Thus, the sample rate converter 1204 may function as a passthrough or may include a bypass path that enables the audio samples to be provided from the sample rate converter 1204 to the host synchronized link 502 without adding latency or adding minimal latency that is substantially less than the latency added by sample rate conversion.

In some embodiments where the sample rate converter 1204 is operating, the audio memory 206 requests audio samples from the sample rate converter 1204. However, in some cases where the host synchronized link 502 is operating and the sample rate converter 1204 is omitted or bypassed, the audio samples are controlled by the speed of the USB link and the host synchronized link 502 determines when to provide samples to the audio memory 206. Further, a handshake process may be completed between the audio memory handshake controller 1008 and the audio memory input handshake controller 1206 to confirm a connection between the host synchronized link 502 and the audio memory 206. Moreover, the audio memory 206 can include a write confirmation circuit 1208 that confirms when the audio sample has been written to the RAM or memory of the audio memory 206.

### Terminology

Conditional language used herein, such as, among others, “can,” “could,” “might,” “may,” “e.g.,” and the like, unless specifically stated otherwise, or otherwise understood within the context as used, may be generally intended to convey that certain embodiments include, while other embodiments do not include, certain features, elements and/or states. Thus, such conditional language may be not generally intended to imply that features, elements and/or states may be in any way required for one or more embodiments or that one or more embodiments necessarily include these features, elements and/or states.

Conjunctive language such as the phrase “at least one of X, Y, and Z,” unless specifically stated otherwise, may be otherwise understood with the context as used in general to convey that an item, term, etc. may be either X, Y, or Z. Thus, such conjunctive language may be not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Additionally, features described in connection with one embodiment can be incorporated into another of the disclosed embodiments, even if not expressly discussed herein, and embodiments may have the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it may be intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example may be to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps may be mutually exclusive. The protection may be not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

Moreover, while operations may be depicted in the drawings or described in the specification in a particular order, such operations need not be performed in the particular order shown or in sequential order, or that all operations be performed, to achieve desirable results. Other operations that may be not depicted or described can be incorporated in the example methods and processes. For example, one or more additional operations can be performed before, after, simultaneously, or between any of the described operations. Further, the operations may be rearranged or reordered in other implementations, including being performed at least partially in parallel. Those skilled in the art will appreciate that in some embodiments, the actual steps taken in the processes illustrated and/or disclosed may differ from those shown in the figures. Depending on the embodiment, certain of the steps described above may be removed, others may be added.

For purposes of this disclosure, certain aspects, advantages, and novel features may be described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that may be within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure may be not intended to be limited by the specific disclosures of preferred embodiments in this section or elsewhere in this specification, and may be defined by claims as presented in this section or elsewhere in this specification or as presented in the future. The language of the claims may be to be interpreted broadly based on the language employed in the claims and not limited to the examples described in the present specification or during the prosecution of the application, which examples may be to be construed as non-exclusive.

Unless the context clearly may require otherwise, throughout the description and the claims, the words “comprise”, “comprising”, and the like, may be construed in an inclusive sense as opposed to an exclusive or exhaustive sense, that may be to say, in the sense of “including, but not limited to”.

What is claimed is:

1. A low-latency transmitter of a wireless audio output system, the low-latency transmitter comprising:
an audio input configured to receive a start of frame signal of a frame and a set of audio samples associated with an audio frame corresponding to the start of frame signal;
a host synchronized link connected to the audio input and including a frame sync generator, a host data controller, and a memory, the frame sync generator configured to generate a frame sync signal in response to the start of frame signal to synchronize audio samples with a start of the audio frame, the host data controller configured to store the set of audio samples at the memory and to control output of the set of audio samples from the memory to an audio memory; and
the audio memory configured to receive for transmission the set of audio samples from the host synchronized link at the end of the audio frame.

2. The low-latency transmitter of claim 1 wherein the host synchronized link bypasses a sample rate converter removing latency in audio transmission associated with the sample rate converter.

3. The low-latency transmitter of claim 1 further comprising a physical timing manager configured to control the host synchronized link and the audio memory.

4. The low-latency transmitter of claim 3 further comprising a baseband processor, the physical timing manager further configured to control the baseband processor.

5. The low-latency transmitter of claim 3 wherein the physical timing manager is further configured to receive the frame sync signal from the frame sync generator and to control synchronization of the audio samples with the start of the frame.

6. The low-latency transmitter of claim 3 wherein the host data controller controls the output of the set of audio samples from the memory to the audio memory based on a synchronized state between the start of frame signal and the physical timing manager.

7. The low-latency transmitter of claim 1 wherein, when the set of audio samples includes less than a particular number of samples, the host data controller concatenates samples from a prior set of audio samples stored at the memory to the set of audio samples.

8. The low-latency transmitter of claim 1 wherein the start of frame signal is received about every 1 millisecond.

9. The low-latency transmitter of claim 1 wherein the audio input is a universal serial bus input.

10. The low-latency transmitter of claim 1 wherein the host data controller includes a first handshake controller configured to establish a connection with the audio input and a second handshake controller configured to indicate if a sample from the set of audio samples is written to the audio memory.

11. The low-latency transmitter of claim 1 wherein a link rate between the low-latency transmitter and a receiver is controlled by a clock of an audio source.

12. The low-latency transmitter of claim 1 wherein the wireless audio output system includes a speaker.

13. The low-latency transmitter of claim 1 wherein the start of frame signal and the set of audio samples are generated by a computing system.

14. A wireless host comprising:
a computing system configured to output audio as a set of audio samples to be wirelessly transmitted to a speaker; and
a transmitter including an audio input, a host synchronized link, and audio memory, the audio input configured to receive a start of frame signal and the set of audio samples from the computing system, the set of audio samples associated with an audio frame corresponding to the start of frame signal, the host synchronized link connected to the audio input and including a frame sync generator, a host data controller, and a first in first out memory, the frame sync generator configured to receive the start of frame signal from the audio input and to generate a frame sync signal in response to the start of frame signal to synchronize audio samples with the start of frame, the host data controller configured to store the set of audio samples at the first in first out memory and to control output of the set of audio samples from the first in first out memory to the audio memory, and the audio memory configured to receive for transmission the set of audio samples associated with the audio frame from the host synchronized link at the end of the audio frame.

15. The wireless host of claim 14 wherein the transmitter further includes a physical timing manager configured to control the host synchronized link and the audio memory.

16. The wireless host of claim 15 wherein the physical timing manager is further configured to receive the frame sync signal from the frame sync generator and to control synchronization of the audio samples with the start of the frame.

17. The wireless host of claim 14 wherein, when the set of audio samples includes less than a particular number of samples, the host data controller includes samples from a prior set of audio samples stored at the first in first out memory with the set of audio samples to obtain the particular number of samples.

18. The wireless host of claim 14 wherein the start of frame signal is generated by a universal serial bus controller that provides the start of frame signal to the audio input.

19. A wireless audio system comprising:
a wireless host configured to wirelessly transmit a set of audio samples to a speaker, the wireless host including a transmitter and a computing system configured to output the set of audio samples to the transmitter, the transmitter including an audio input, a host synchronized link, and audio memory, the audio input configured to receive a start of frame signal and the set of audio samples from the computing system, the set of audio samples associated with an audio frame corresponding to the start of frame signal, the host synchronized link connected to the audio input and including a frame sync generator, a host data controller, and a memory, the frame sync generator configured to receive the start of frame signal from the audio input and to generate a frame sync signal in response to the start of frame signal to synchronize audio samples with the start of frame, the host data controller configured to store the set of audio samples at the memory and to control output of the set of audio samples from the memory to the audio memory, and the audio memory configured to receive for transmission the set of audio samples associated with the audio frame from the host synchronized link at the end of the audio frame; and
a wireless client configured to wirelessly receive the set of audio samples to output audio corresponding to the set of audio samples using the speaker.

20. The wireless audio system of claim 19 wherein the transmitter further includes a physical timing manager configured to receive the frame sync signal from the frame sync generator and to control synchronization of the audio samples with the start of the frame.
